(19) United States
(12) Patent Application Publication
(10) Pub. No.: US 2014/0327253 A1
(43) Pub. Date: Nov. 6, 2014

(54) VEHICLE LATCH ASSEMBLY

(71) Applicant: KM&I. CO., LTD., Incheon (KR)

(72) Inventors: Jong-Chan Lee, Incheon (KR); Min Yi Gil, Seoul (KR)

(21) Appl. No.: 14/001,755

(22) PCT Filed: Dec. 18, 2012
(86) PCT No.: PCT/KR2012/011086

§ 371 Date: Aug. 27, 2013

(30) Foreign Application Priority Data
Dec. 22, 2011 (KR) 10-2011-0140142

(51) Int. Cl. E05B 17/00

(52) U.S. Cl. CPC E05B 17/0045
USPC 292/341.12

(57) ABSTRACT

Provided is a vehicle latch assembly for locking or unlocking a seat back of a vehicle seat capable of decreasing vibrations and noise of the seat back by forming a wedge part so that a tolerance is not generated in a state in which the seat back is latched.

### TECHNICAL FIELD

The present invention relates to a vehicle latch assembly for locking or unlocking a seat back of a vehicle seat, and more particularly, to a vehicle latch assembly capable of decreasing vibrations and noise of a seat back by forming a wedge part so that a tolerance is not generated in a state in which the seat back is latched.

### BACKGROUND ART

Generally, vehicle seats, which are configured of a seat cushion and a seat back to maintain a boarding attitude of a passenger, are provided on a driver seat and a passenger seat and are divided into a separator type seat on which only one person may be seated and a bench type seat provided behind the driver seat and the passenger seat so that several persons may be simultaneously seated thereon.

The separator type seat provided at the driver seat and the passenger seat may be adjusted in accordance with body types of a driver and a passenger so that the driver and the passenger may maintain an attitude appropriate for driving, and a seat back serving as a back support so that the passenger may take a rest is provided with a reclining apparatus adjusting an angle forward or backward.

The bench type seat provided at the rear of the vehicle is provided with a seat back latch assembly allowing the seat back to be folded forward in order to mount a load having a large volume or a long length in a trunk.

The latch assembly includes a striker kit and a latch kit. The striker kit for fixing the seat back is fixedly installed at an adjacent part of the seat back, and the latch kit locked to or unlocked from the striker kit is installed at the seat back. The latch kit includes a latch part provided with a tooth having the striker kit fitted thereinto to maintain the seat back in a locked state, a locking part fixing the latch part to the striker kit or separating the latch part from the striker kit, and a knob controlling the locking part.

In the latch assembly having the above-mentioned structure, when the knob is pulled in order to unlock the seat back in a locked state, the locking part is rotated to separate the striker kit fitted into the tooth of the latch part from the latch kit, such that the seat back is folded.

However, in the latch assembly according to the related art as described above, when the striker kit is fitted into and fixed to the latch kit, a tolerance of the latch part and the locking part may be generated.

Therefore, a locking defect, a clearance, or the like, of the seat back is generated. Further, vibrations or noise of the seat back is generated, such that sensitive quality of a user is deteriorated.

In addition, in accordance with the trend toward enhancement of laws due to a safety problem, specifications of the latch assembly such as high strength have been demanded. In the case in which a load is applied to the seat back in a direction in which the striker kit is separated in a state in which the latch kit is locked to the striker kit in order to test strength of the latch assembly, the latch part is damaged. As a result, the latch assembly according to the related art does not satisfy demanded strength.

Therefore, development of a high strength latch assembly capable of locking and fixing the seat back without a tolerance and satisfying a safety law has been demanded.

### DISCLOSURE

### Technical Problem

An object of the present invention is to provide a vehicle latch assembly capable of minimizing generation of a tolerance at the time of locking a latch kit to a striker kit by additionally installing a wedge part at a shaft at which a locking part is installed so as to be rotatable together with the locking part and allowing the wedge part to press the latch part by elasticity thereof.

### Technical Solution

In one general aspect, a vehicle latch assembly includes: a striker kit fixed to an adjacent part of a seat back in order to fold the seat back; and a latch kit installed at the seat back and locked to or unlocked from the striker kit, wherein the latch kit includes: a housing provided with a slit groove so that the striker kit is slid; a latch part rotatably installed at a first shaft disposed in the housing and provided with a tooth so that it is rotated in one direction to allow the striker kit to be fitted into the tooth and is rotated in the other direction to allow the striker kit to be separated from the tooth; a locking part rotatably installed at a second shaft disposed in the housing, rotated in one direction to rotate the latch part in one direction so that the striker kit is separated from the tooth, and rotated in the other direction to lock the latch part so that the striker kit is maintained in a state in which it is fitted into the tooth; and a wedge part disposed in the housing so as to press the latch part when the striker kit is fitted into the tooth.

The wedge part may be rotatably installed on the second shaft, press the latch part by elastic force of an elastic member, and be installed together with the locking part so as to release the pressing of the latch part when the locking part is rotated in one direction.

A circumference of a side of the wedge part that is in parallel with the second shaft may line-contact a circumference of a side of the latch part that is in parallel with the first shaft, such that the wedge part presses the latch part.

The elastic member may be a torsion spring installed on the second shaft.

### Advantageous Effects

With the vehicle latch assembly according to the exemplary embodiment of the present invention having the configuration as described above, since generation of a tolerance of the latch kit and the striker kit is minimized, generation of vibrations and noise is prevented at the time of locking the seat back, thereby making it possible to significantly satisfy sensitive quality of a vehicle passenger.

In addition, the wedge part serves as an auxiliary stopper at the time of locking the latch kit to the striker kit, thereby making it possible to secure locking strength and satisfy a safety law of the latch assembly.

### DESCRIPTION OF DRAWINGS

FIG. 1 is a perspective view of the entire latch assembly according to an exemplary embodiment of the present invention.

FIG. 2 is an exploded perspective view of the latch assembly to the exemplary embodiment of the present invention.

FIG. 3 is a perspective view of a latch part according to the exemplary embodiment of the present invention.

FIG. 4 is a perspective view of a locking part according to the exemplary embodiment of the present invention.

FIG. 5 is a perspective view of a wedge part according to the exemplary embodiment of the present invention.

FIG. 6 is a front perspective view of the latch assembly to the exemplary embodiment of the present invention.

FIGS. 7 to 9 are views showing an operation state of the latch assembly according to the exemplary embodiment of the present invention.

[Detailed Description of Main Elements]

| | |
|---|---|
| S: Striker kit | L: Latch kit |
| 10: First shaft | 20: Second shaft |
| 30: Latch part | 40: Locking part |
| 50: Wedge part | 60: Louver |
| 70: Knob | S1: First elastic member |
| S2: Second elastic member | |

### BEST MODE

Hereinafter, an exemplary embodiment of the present invention will be described in detail with reference to the accompanying drawings.

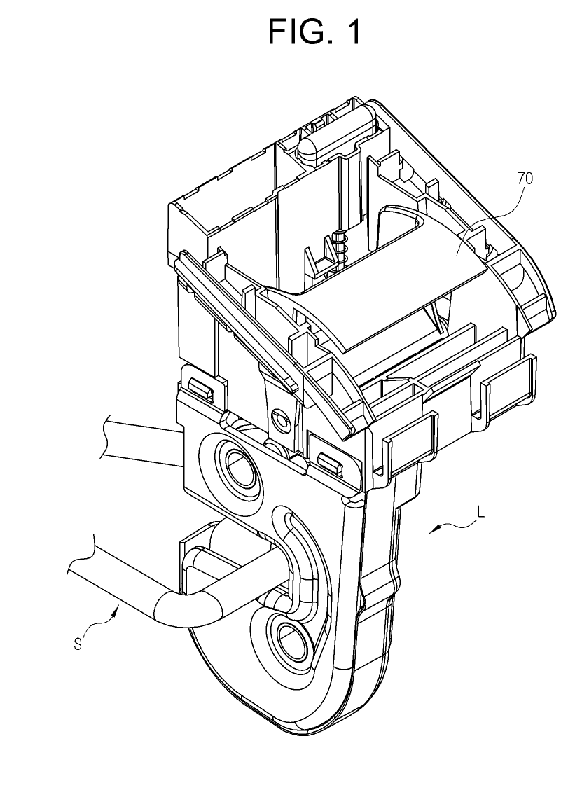

Referring to FIG. 1, a latch assembly according to an exemplary embodiment of the present invention may be mainly configured of a striker kit S and a latch kit L. The latch kit L may be mainly installed at an upper side of a seat back of a vehicle, and the striker kit S may be installed at a frame of a vehicle body corresponding to the latch kit L at the time of fixing the seat back. Since detailed installation configurations of the latch kit L and the striker kit S correspond to a configuration of a general latch assembly, a detailed description thereof will be omitted.

Therefore, at the time of fixing the seat back, the striker kit S is fitted into the latch kit L. At the same time, the latch kit L maintains a state in which the striker kit S is fitted thereinto, such that the seat back may be fixed. In addition, at the time of folding the seat back, a knob 70 of the latch kit L is pulled to allow the latch kit L to release the striker kit S, such that the seat back may be folded.

The striker kit S may be formed of a rod having a circular or a slot shaped cross section. Since the striker kit S may have a configuration corresponding to that of a striker kit of a general latch assembly, a detailed description thereof will be omitted.

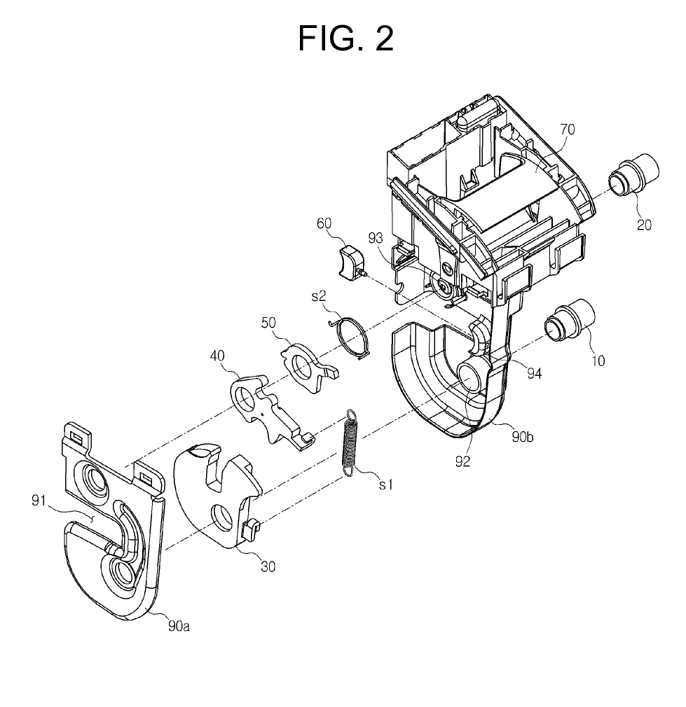

Referring to FIGS. 1 and 2, the latch kit L according to the exemplary embodiment of the present invention is configured to include a first shaft 10, a second shaft 20, a latch part 30, a locking part 40, a wedge part 50, a louver 60, a knob 70, a first elastic member S1, a second elastic member S2, and housings 90a and 90b.

The housings 90a and 90b fix the latch kit L to the seat back, receive components of the latch kit L therein, and are formed of a bracket allowing an operation to be smoothly performed. The housings 90a and 90b include a first housing 90a and a second housing 90b. The second housing 90b is formed in a case shape in which a front surface thereof is opened so that the components of the latch kit L may be received, and the first housing 90a is formed in a plate shape so as to close the opened front surface of the second housing 90b.

The housings 90a and 90b are provided with a first fixing hole 92 to which the first shaft 10 for hinge-rotating the latch part 30 is fixed. The housings 90a and 90b are provided with a second fixing hole 93 to which the second shaft 20 for hinge-rotating the locking part 40 and the wedge part 50 is fixed. Although the case in which the first and second shafts 10 and 20 are formed separately from the housings 90a and 90b has shown in FIG. 2, the first and second shafts 10 and 20 may also be formed integrally with the housings 90a and 90b.

The housings 90a and 90b include a slit groove 91 formed in a direction in which the latch kit L is locked or unlocked so that the striker kit S is slid. The slit groove 91 may be formed to be opened toward the striker kit S in a width direction of the housings 90a and 90b and be closed in a direction in which the seat back is folded. When a direction in which the latch kit L is locked or unlocked is defined as an x direction and a direction in which the striker kit S is formed is defined as a y direction, the x and y directions may be perpendicular to each other.

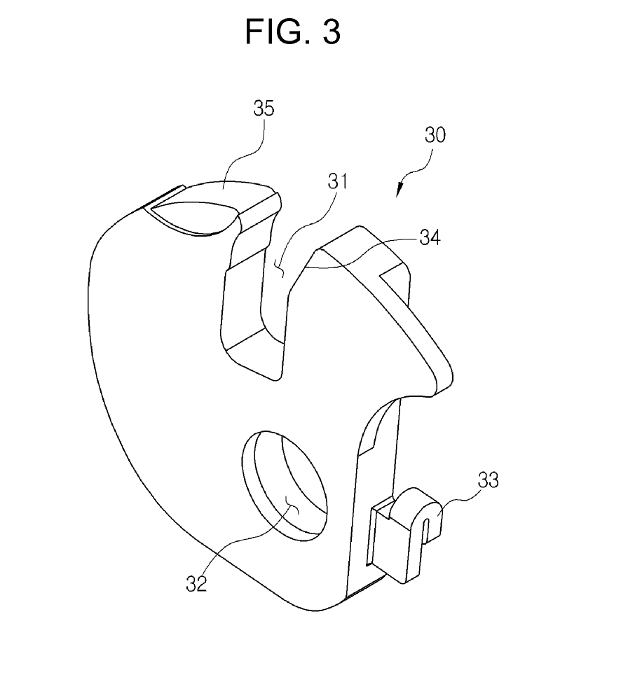

Referring to FIGS. 2 and 3, the latch part 30 is formed in a plate shape. The latch part 30 may be provided with a tooth 31, a latch hole 32, a first protrusion part 33, a locking surface 34, and a wedge surface 35. The latch hole 32 formed at the other side of a lower end of the latch part 30 in FIG. 3 is fitting-coupled to the first shaft 10, and the latch part 30 is coupled to the second housing 90b so as to be rotatable in a clockwise direction or a counterclockwise direction around the latch hole 32. The tooth 31 is depressed downwardly from the center of an upper side of the latch part 30 by a predetermined distance. The tooth 31 is configured to be engaged with the striker kit S and has a width that becomes smaller in a downward direction so as to firmly fix the striker kit S when the striker kit S is fitted thereinto.

When the latch part 30 is installed at the second housing 90b, a distal end of the tooth 31 coincides with the slit groove 91 at the time of unlocking the latch part 30, and when the striker kit S is slid inwardly along the slit groove 91 to thereby be engaged with the tooth 31, the latch part 30 is rotated in the clockwise direction and is fixed at a point at which a direction in which the tooth 31 is formed is perpendicular to a direction in which the slit groove 91 is formed, such that the latch kit L is maintained in a locked state. The other side of the tooth 31 is provided with the locking surface 34 for fixing the locking part 40. A circumferential surface of one side of the tooth 31 on the latch part 30 is provided with the wedge surface 35 contacting the wedge part 50 and pressed by the wedge part 50. In addition, a circumferential surface of the other side of the latch hole 32 on the latch part 30 is provided with the first protrusion part 33 for fixing the other end of the first elastic member S1. The first protrusion part 33 may have a hook shape in order to fix a distal end of the elastic member having a general ring shape.

The louver 60 may be installed to contact a circumferential surface of the other side of the latch part 30 when the latch kit L is locked to the striker kit S. The louver 60 may be made of an elastic material such as rubber. The louver 60 is configured to absorb impact that may be instantaneously generated at the latch part 30 when the latch kit L is locked to the striker kit S at the time of fixing the seat back.

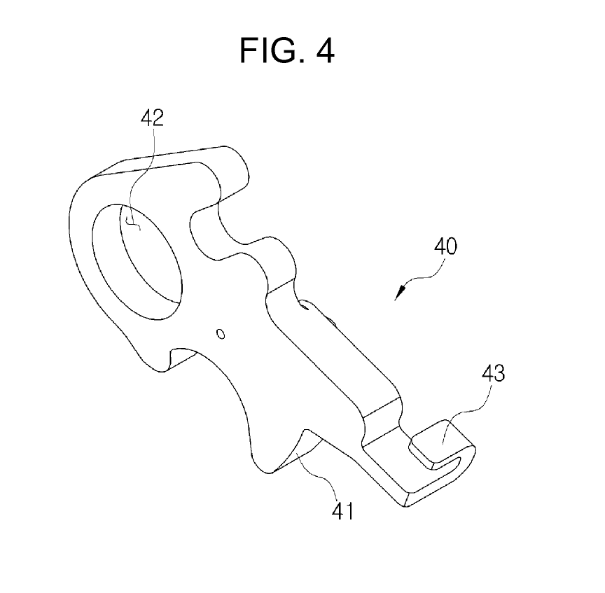

Referring to FIGS. 2 and 4, the locking part 40 is formed in a long plate shape. The locking part 40 is provided with a latch locking surface 41, a locking hole 42, a second protrusion part 43, and a knob fixing groove (not shown). The locking hole 42 formed at one end of the locking part 40 in FIG. 4 is fitting-coupled to the second shaft 20, and the locking part 40 is coupled to the second housing 90b so as to be rotatable in the clockwise direction or the counterclockwise direction around the locking hole 42. The latch locking surface 41 is formed at the other end of the locking part 40. The latch locking surface 41 is configured to surface-contact the locking surface 34 of the latch part 30 so that the striker kit S is fitted into the tooth 31 of the latch part 30, such that the latch kit L is maintained in the locked state. In addition, the other end surface of the locking part 40 is provided with the second protrusion part 43 for fixing one end of the first elastic member S1. The second protrusion part 43 may have a hook shape in order to fix a distal end of the elastic member having a general ring shape. A circumference of the locking hole 42 is provided with a knob fixing groove (not shown) to which a distal end of the knob 70 for rotating the locking part 40 in the counterclockwise direction is fixed. The first elastic member S1 may be an attractive force coil spring. The first elastic member S1 has one end fixed to the second protrusion part 43 and the other end fixed to the first protrusion part 33. The first elastic member S1 applies elastic force to the latch part 30 so that the latch part 30 is rotated in the counterclockwise direction and applies the locking part 40 so that the locking part 40 is rotated in the clockwise direction.

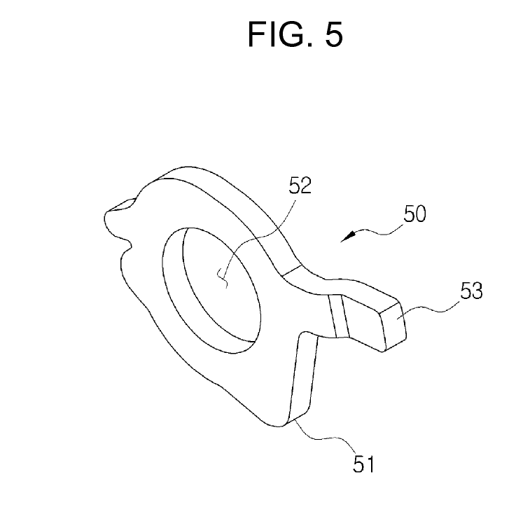

Referring to FIGS. 2 and 5, the wedge part 50 is formed in a plate shape. The wedge part 50 may be provided with a latch pressing surface 51, a wedge hole 52, and a third protrusion part 53. The wedge hole 52 formed at the center of the wedge part 50 is fitting-coupled to the second shaft 20, and the wedge part 50 is coupled to the second housing 90b so as to be rotatable in the clockwise direction or the counterclockwise direction around the wedge hole 52. The latch pressing surface 51 is protrudedly formed at the other end surface of the wedge part 50. The latch pressing surface 51 is configured to line-contact the wedge surface 35 of the latch part 30 so that a clearance is not generated when the striker kit S is fitted into the tooth 31 of the latch part 30, such that the latch kit L is maintained in the locked state. The wedge part 50 is connected to the second elastic member S2 provided on the second shaft 20. The second elastic member S2 may be a torsion spring. The wedge part 50 is configured to be applied with elastic force in the clockwise direction around the wedge hole 52 by the second elastic member S2. Therefore, the wedge part 50 is configured to press the latch part 30 by line-contact between the latch pressing surface 51 and the wedge surface 35. In addition, the other end surface of the wedge part 50 is provided with the third protrusion part 53 so as to release the pressing of the latch part 30 when the locking part 40 is rotated in one direction. The third protrusion part 53 is configured to contact the locking part 40 when the locking part 40 is rotated in one direction, thereby rotating the wedge part 50 in one direction.

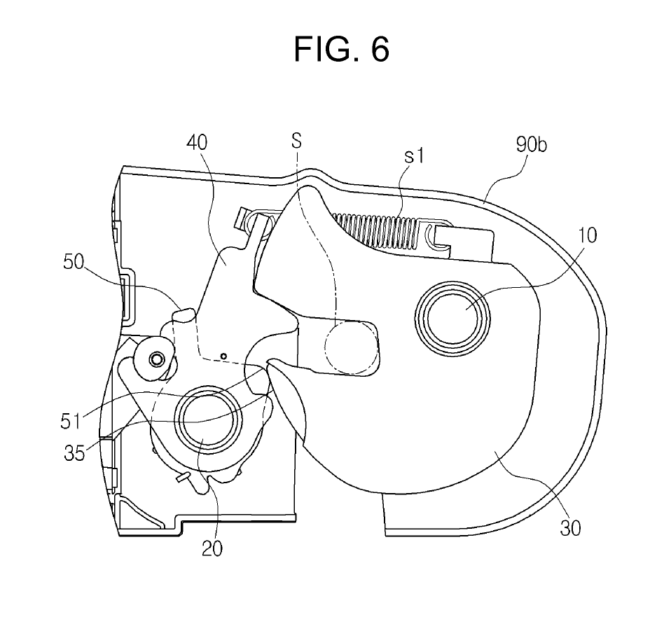

Through the configuration of the wedge part 50 as described above, when the striker kit S is fitted into the latch part 30, such that the latch kit L is maintained in the locked state as shown in FIG. 6, the latch pressing surface 51 presses the wedge surface 35, thereby minimizing generation of a tolerance of the latch part 30.

In addition, in the case in which a load is applied to the seat back in a direction in which the striker kit S is separated in a state in which the latch kit L is locked to the striker kit S in order to test strength of the latch assembly, the wedge part 50 presses the latch part 30, thereby preventing damage to a lower portion of the latch part 30 and ensuring strength of the latch kit L.

Hereinafter, an operation of the latch assembly according to the exemplary embodiment of the present invention configured as described above will be described with reference to the accompanying drawings.

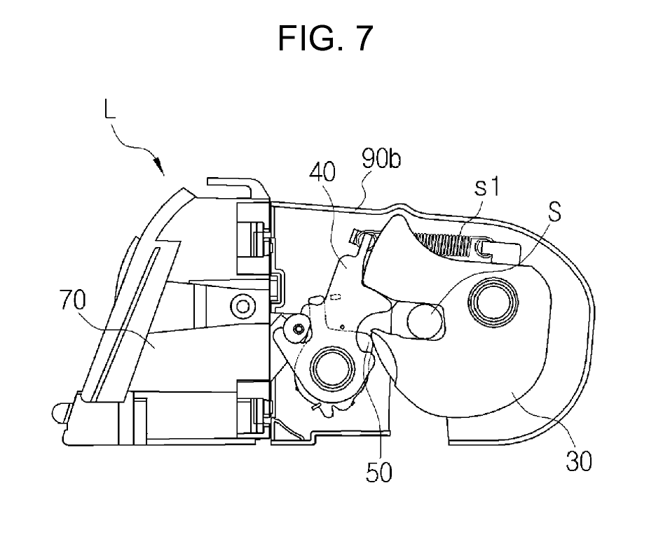

In FIG. 7, which is a view showing a state in which the latch assembly is locked, the striker kit S is in a state in which it is fitted into and fixed to the latch part 30, and the latch part 30 maintains the state in which the striker kit S is fitted thereinto and fixed thereto through the locking part 40. In this case, the latch part 30 is pressed by rotational force of the wedge part 50 in the clockwise direction to make the state in which the latch assembly is locked more firm and prevent generation of a clearance.

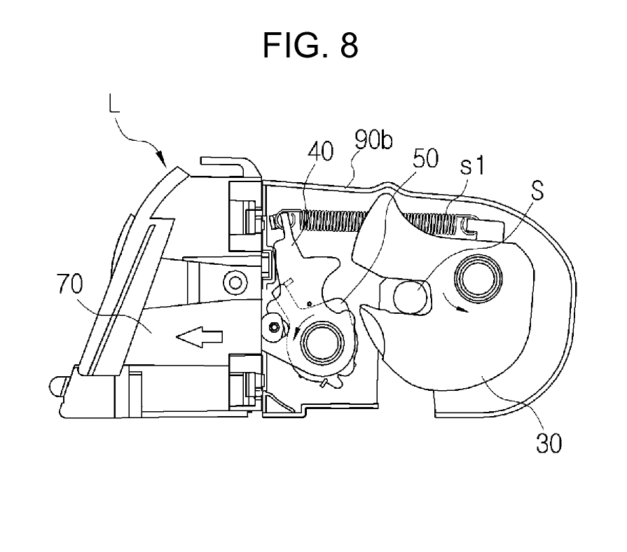

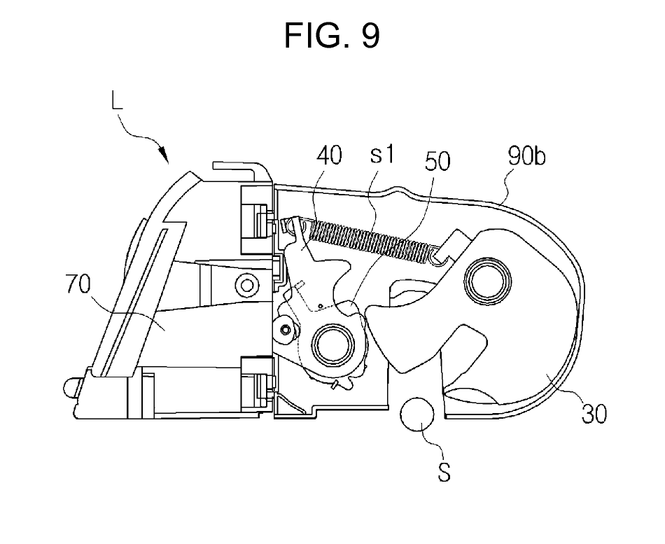

In FIGS. 8 and 9, which are views showing a process in which the latch assembly is unlocked, when the knob 70 is pulled in an arrow direction, the locking part 40 is rotated in the counterclockwise direction and the fixing of the latch part 30 engaged with the locking part 40 is released. At the same time, the latch part 30 is also rotated in the counterclockwise direction by the elastic force of the first elastic member S1 connected to the locking part 40. The striker kit S fitted into and fixed to the latch part 30 is separated downwardly from the latch part 30 by the rotation of the latch part 30 in the counterclockwise direction. In this case, the wedge part 50 pressing the latch part 30 is rotated in the counterclockwise direction together with the locking part 40 rotated in the counterclockwise direction to release the pressing of the latch part 30.

The present invention should not be construed to being limited to the above-mentioned exemplary embodiment. The present invention may be applied to various fields and may be variously modified by those skilled in the art without departing from the scope of the present invention claimed in the claims. Therefore, it is obvious to those skilled in the art that these alterations and modifications fall in the scope of the present invention.

1. A vehicle latch assembly comprising:
a striker kit fixed to an adjacent part of a seat back in order to fold the seat back; and
a latch kit installed at the seat back and locked to or unlocked from the striker kit,
wherein the latch kit includes:
a housing provided with a slit groove so that the striker kit is slid;
a latch part rotatably installed at a first shaft disposed in the housing and provided with a tooth so that it is rotated in one direction to allow the striker kit to be fitted into the tooth and is rotated in the other direction to allow the striker kit to be separated from the tooth;
a locking part rotatably installed at a second shaft disposed in the housing, rotated in one direction to rotate the latch part in one direction so that the striker kit is separated from the tooth, and rotated in the other direction to lock the latch part so that the striker kit is maintained in a state in which it is fitted into the tooth; and
a wedge part disposed in the housing so as to press the latch part when the striker kit is fitted into the tooth.

2. The vehicle latch assembly of claim 1, wherein the wedge part is rotatably installed on the second shaft and presses the latch part by elastic force of an elastic member.

3. The vehicle latch assembly of claim 2, wherein the wedge part is installed together with the locking part so as to release the pressing of the latch part when the locking part is rotated in one direction.

4. The vehicle latch assembly of claim 2, wherein a circumference of a side of the wedge part that is in parallel with the second shaft line-contacts a circumference of a side of the latch part that is in parallel with the first shaft, such that the wedge part presses the latch part.

5. The vehicle latch assembly of claim 2, wherein the elastic member is a torsion spring installed on the second shaft.
